(19) United States
(12) Patent Application Publication
(10) Pub. No.: US 2026/0273681 A1
(43) Pub. Date: Sep. 17, 2026

(54) CLEVIS PIN ARRANGEMENT FOR A HYDRAULIC TOOL

(71) Applicant: Milwaukee Electric Tool Corporation, Brookfield, WI (US)

(72) Inventors: Harrison T. Snyder, Brookfield, WI (US); Kyle R. Beyers, Brookfield, WI (US)

(21) Appl. No.: 19/562,499

(22) Filed: Mar. 10, 2026

Related U.S. Application Data
(60) Provisional application No. 63/770,036, filed on Mar. 11, 2025.

(51) Int. Cl. B23Q 17/00; B23D 35/00

(52) U.S. Cl. CPC B23Q 17/003; B23D 35/002

(57) ABSTRACT

A power tool includes a tool body having a user input and a controller to control operation in response to a first signal from the user input, a yoke coupled to the tool body with a first leg defining a first aperture and a second leg defining a second aperture, and a clevis. The clevis includes a pin insertable into the apertures and rotatable relative to the yoke to transition between locked and unlocked configurations to removably couple a jaw assembly to the yoke, and a lever at a second end of the pin positioned external to the yoke. A sensor is coupled to the tool body, yoke, or housing to sense the clevis configuration, sending a second signal to the controller to provide an indication to a user.

### CROSS-REFERENCE TO RELATED APPLICATIONS

This application claims priority to U.S. Provisional Application No. 63/770,036, filed on Mar. 11, 2025, which is hereby incorporated by reference in its entirety.

### BACKGROUND

The present disclosure relates to clevis pin arrangements for hydraulic tools, and more specifically, systems and methods or maintaining or indicating when a clevis is in a locked or unlocked configuration.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to one aspect of the present disclosure, a power tool is provided. The power tool can include a tool body including a user input and a controller to control operation of the power tool based in response to a first signal from the user input. The power tool may also include a yoke coupled to the tool body and including a first leg defining a first aperture and a second leg defining a second aperture. The power tool can include a clevis including a pin that is insertable into the first aperture and the second aperture and rotatable relative to the yoke to transition the clevis between a locked configuration and an unlocked configuration to removably couple a jaw assembly to the yoke, and a lever at a second end of the pin that is positioned external to the yoke. The power tool may include a sensor coupled to at least one of the tool body, the yoke, or a housing of the power tool to sense when the clevis is in one of the locked configuration or the unlocked configuration. The sensor can send a second signal to the controller so that the controller provides an indication to a user corresponding to the configuration of the clevis.

In some examples, the sensor may be a hall-effect sensor.

In some examples, the sensor may be coupled to the tool body and the yoke may be rotatable relative to the tool body.

In some examples, the controller may control an activation state of a light visible through a window on the yoke to provide the indication to the user based on the sensed configuration of the clevis.

In some examples, the power tool may further include a lock that is coupled to the lever. The lock may engage the yoke to resist movement of the clevis away from the locked configuration.

In some examples, the lock may include a locking member that is retained in a recess in the lever.

In some examples, the lock may include a spring to bias the locking member into contact with the yoke in the locked configuration.

In some examples, the spring may be a leaf spring that is formed as a unitary component with the locking member.

In some examples, the locking member may apply a force to the yoke to bias the pin in a direction out of the first aperture and the second aperture to engage a yoke detent with a notch defined at the second end of the pin.

In some examples, the sensor may be an inductive sensor that detects a metallic component on the lever.

In some examples, the sensor may include a sensing element that extends circumferentially around the yoke.

In some examples, the lever may include a detectable element at a distal end of the lever. The detectable element may be configured to interact with the sensor when the lever is in the locked configuration.

According to another aspect of the present disclosure, a clevis for removably coupling a working head to a power tool is provided. The clevis can include a pin having a first end and a second end opposite the first end. The pin may define a circumferential channel extending around an outer surface of the pin at the second end and a notch formed within the channel. The notch can extend radially inward from the channel. The clevis may include a lever coupled to the second end of the pin and configured to rotate the pin between a locked configuration and an unlocked configuration. The lever may define a recess. The clevis can include a lock including a locking member retained in the recess. The locking member may extend out of the recess to provide frictional engagement in the locked configuration.

In some examples, the lever may be oriented substantially parallel to an axis of the power tool in the locked configuration.

In some examples, the locking member may be made of an elastomeric material.

In some examples, the lever may include a detectable element at a distal end of the lever configured to interact with a sensor when the lever is in the locked configuration.

In some examples, the locking member may have an outer surface that is concave relative to a leg of the power tool.

According to yet another aspect of the present disclosure, a power tool is provided. The power tool can include a housing. The power tool may include a yoke rotatably coupled to the housing. The yoke can have a first leg with a first aperture and a second leg with a second aperture. The power tool may include a clevis pin extending through the first aperture and the second aperture. The clevis pin can be rotatable between a locked configuration securing a working head to the yoke and an unlocked configuration permitting removal of the working head. The power tool may include a lever coupled to the clevis pin and positioned external to the second leg. The lever can be movable to rotate the clevis pin between the locked configuration and the unlocked configuration. The power tool may include a sensor that detects a position of the lever. The power tool can include a controller that disables operation of the power tool when the sensor detects the clevis pin is in the unlocked configuration.

In some examples, the lever may be positioned to block a workspace defined between a first jaw and a second jaw of the working head in the unlocked configuration, preventing a workpiece from being inserted into the workspace.

In some examples, the sensor may extend circumferentially around the yoke and the lever may include a sensed element at a distal end of the lever that is detectable by the sensor in the locked configuration.

### BRIEF DESCRIPTION OF THE DRAWINGS

The accompanying drawings, which are incorporated in and form a part of this specification, illustrate embodiments of the disclosure and, together with the description, serve to explain principles of the embodiments:

FIG. 1 is a hydraulic tool according to the present disclosure.

FIG. 2 is a diagrammatic view of the hydraulic tool of FIG. 1.

FIG. 3 is an exploded view of a clevis pin arrangement for the hydraulic tool of FIG. 1 including a clevis pin and a clevis lever.

FIG. 4 is a front, right, view of the clevis pin and the clevis lever of FIG. 3.

FIG. 5 is a front, right, view of a lock assembly for a clevis lever for the hydraulic tool of FIG. 1.

FIG. 6 is a front, right, view of a lock assembly having a leaf spring for a clevis lever for the hydraulic tool of FIG. 1.

FIG. 7A is a front view of the clevis pin arrangement of FIG. 3 in a locked configuration.

FIG. 7B is a right, side view of the clevis pin arrangement of FIG. 3 in the locked configuration.

FIG. 8A is a front view of the clevis pin arrangement of FIG. 3 in an intermediate configuration.

FIG. 8B is a front view of the clevis pin arrangement of FIG. 3 in an unlocked configuration.

FIG. 9A is an axonometric view of a clevis pin arrangement for the hydraulic tool of FIG. 1 in the locked configuration according to another embodiment of the present disclosure.

FIG. 9B is an axonometric of the clevis pin arrangement of FIG. 9A in an unlocked configuration.

FIG. 9C is an axonometric view of the clevis pin arrangement of FIG. 9A in an unlocked and withdrawn configuration.

### DETAILED DESCRIPTION

As briefly noted above, hydraulic tools can employ clevis pin arrangements to removably couple working heads, such as crimping or cutting jaws, to a tool body. The ability to interchange working heads can provide operational flexibility, allowing a single tool to perform a variety of tasks by swapping between different working heads. For instance, a user may need to switch between different crimping dies to accommodate various connector sizes, or replace cutting blades suited for different cable diameters. Additionally, the ability to remove and replace working heads facilitates maintenance and repair, such as when a set of jaws becomes worn or damaged and requires replacement with a functional set.

Given the interchangeable nature of working heads, it can be beneficial for a user to have confirmation that the working head has been correctly installed and securely locked to the tool before operation. In some aspects, a clevis pin arrangement may include features that maintain or indicate when a clevis is in a locked or unlocked configuration. For example, a lock assembly may be coupled to a lever of the clevis to resist movement of the clevis away from the locked configuration. In some cases, a sensor may detect the configuration of the clevis, such as by sensing when the clevis pin is in the locked configuration. The sensor may provide an indication to a user, such as a visual, auditory, or haptic indication. A controller may also disable operation of the tool when the clevis is in the unlocked configuration. These features may enhance operational reliability and user awareness during use of the tool.

In some aspects, a clevis pin arrangement may include a stop pin that engages the clevis pin to maintain the clevis in the locked configuration. The clevis pin may define a channel that extends circumferentially around the pin and a notch formed within the channel. The stop pin may engage the notch to resist rotational movement of the clevis pin until a user applies sufficient force to disengage the stop pin from the notch. The channel may provide a continuous path that allows the stop pin to remain in contact with the clevis pin as the clevis pin rotates between the locked configuration and the unlocked configuration.

In some aspects, a lock assembly may be coupled to a lever of the clevis to resist movement of the clevis away from the locked configuration. The lock assembly may include a locking member retained in a recess defined on an interior surface of the lever. The locking member may extend past the interior surface to engage the yoke in the locked configuration. In some cases, the locking member may be made of an elastomeric material to increase frictional engagement between the lever and the yoke. In other cases, the lock assembly may include a biasing assembly to bias the locking member into engagement with the yoke. The biasing assembly may include a resilient member, such as a leaf spring, a compression spring, a torsion spring, or another biasing element. In some aspects, the biasing assembly may be integrally formed with the locking member as a unitary component. In other aspects, the biasing assembly may be a separate element from the locking member.

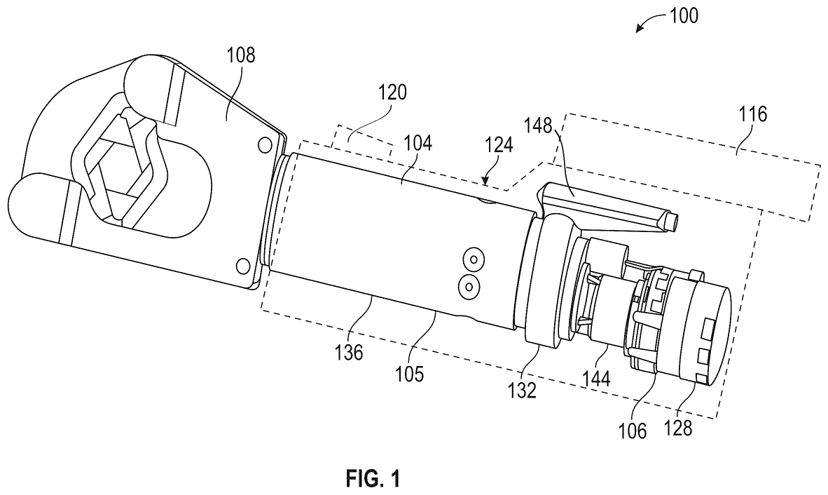

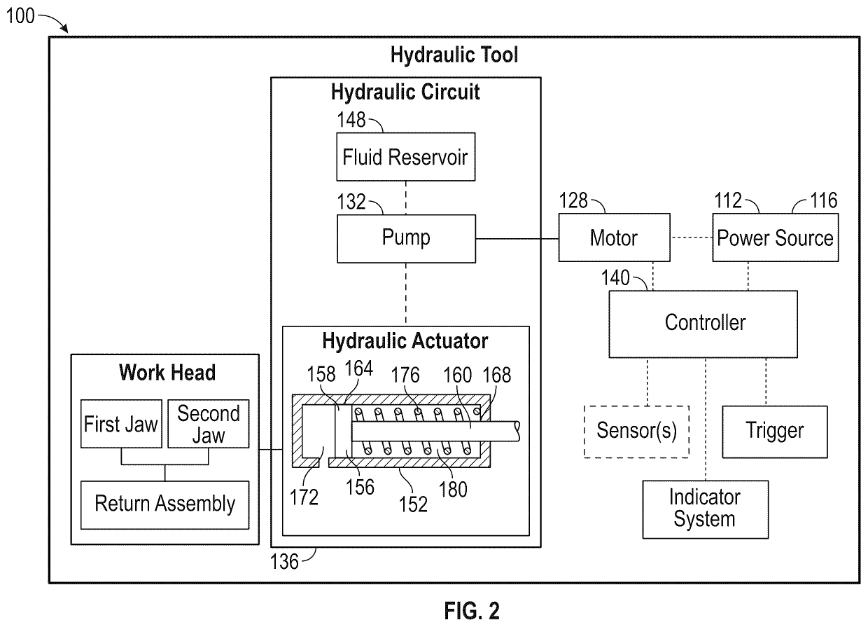

FIGS. 1 and 2 illustrate an example of a hydraulic tool 100, in accordance with the present disclosure. Although the example implementation described herein references a cutting tool, the features of this disclosure can be implemented in other similar tools, such as crimping tools or punching tools. In addition, any suitable size, shape or type of elements or materials could be used. The illustrated hydraulic tool 100 includes a housing 104 and a working head 108 that is coupled to the housing 104 to perform an operation on a work piece. The working head 108 is illustrated as a crimping head; however other types of working heads can also be used. The housing 104 defines a cylinder housing 105 that is attached to the working head 108 and a pump housing 106. The cylinder housing 105 includes a cylinder 152 and the pump housing 106 includes a pump 132. In some examples, the hydraulic tool 100 can be battery-operated and the housing 104 can define a battery receptacle 112 that is configured to receive a battery 116. In other examples the hydraulic tool 100 can be corded.

To operate the hydraulic tool 100, a user input, such as a trigger 120 is coupled to the housing 104. The trigger 120 can be manipulated by a user to actuate the hydraulic tool 100 and perform the work operation. For example, actuating the trigger 120 can control operation of an output assembly 124 that is disposed within the housing 104. The output assembly 124 includes a motor 128, the pump 132, and a hydraulic actuator 136 that acts on the working head 108 to perform the work operation. When the trigger 120 is pressed, electrical current can flow from the battery 116 to output assembly 124, causing the output assembly 124 to operate the working head 108 to perform the work operation. In some cases, the trigger 120 can communicate with an electronic controller 140 that controls a flow of electrical current from the battery 116 or another power source. For example, the trigger 120 can send a first signal to the controller 140, and the controller 140 can control operation of the hydraulic tool 100 in response to the first signal from the trigger 120. More specifically, the electrical current can be provided to the motor 128 of the output assembly 124. The motor 128 can be coupled to the pump 132 so that rotation of the motor 128 operates the pump 132 to supply pressurized hydraulic fluid to the hydraulic actuator 136. In some cases, the motor 128 can be coupled to the pump 132 via a transmission 144 (e.g., a gear reducer).

Still referring to FIGS. 1-2, the hydraulic tool 100 includes the hydraulic actuator 136. The pump 132 supplies hydraulic fluid from a reservoir 148 (e.g., a tank) to the hydraulic cylinder 152. In general, the hydraulic cylinder 152 includes a piston 156 having piston head 158 and a piston rod 160. The piston 156 is moveably received in the cylinder 152 to form a first chamber 172 and a second chamber 180 within internal volume of the cylinder 152. A piston seal 164 is provided to seal between the piston head 158 and the cylinder 152 to prevent fluid from leaking between the first chamber 172 and the second chamber 180. A rod seal 168 is provided to seal between the cylinder 152 and the piston rod 160 to prevent hydraulic fluid from leaking out of the cylinder 152.

To operate the hydraulic actuator 136, the hydraulic cylinder 152 uses pressurized fluid to create mechanical motion. For example, hydraulic fluid is pumped into the first chamber 172. The pressure acting on the surface area of the piston 156 generates a force that causes to move the piston 156 to move within the cylinder 152 between a first position (e.g., a retracted position or an extended position) and a second position (e.g., the other of the retracted position and the extended position). In some cases, the hydraulic cylinder 152 is single acting. For example, hydraulic fluid is pumped to apply pressure to one side (e.g., first chamber 172) of the piston 156. Therefore, the piston 156 can only move in one direction by the generation of the force. A return mechanism 176 (e.g., spring or gravity) is used to return the piston 156 from the second position to the first position. In other cases, the hydraulic cylinder 152 is double-acting. For example, hydraulic fluid is pumped to apply pressure to both sides (e.g., the first chamber 172 and a second chamber 180) of the piston 156. Hydraulic fluid creates pressure along the surface in the first chamber 172, generating a force to move the piston 156 between the first position and the second position. To move the piston 156 between the second position and the first position, hydraulic fluid creates pressure along the surface in the second chamber 180 to generate a force.

In some cases, a working head of a power tool can have interchangeable jaws that are supported on a yoke of the housing so that a user can switch between different crimping operations, cutting operations, etc. In particular, the yoke is configured to engage with a clevis pin mechanism that allows a user to attach and remove jaws from the yoke. For example, a clevis pin of the clevis pin mechanism that is movable between a locked configuration and an unlocked configuration relative to the yoke allows a user to selectively secure the jaws to the yoke.

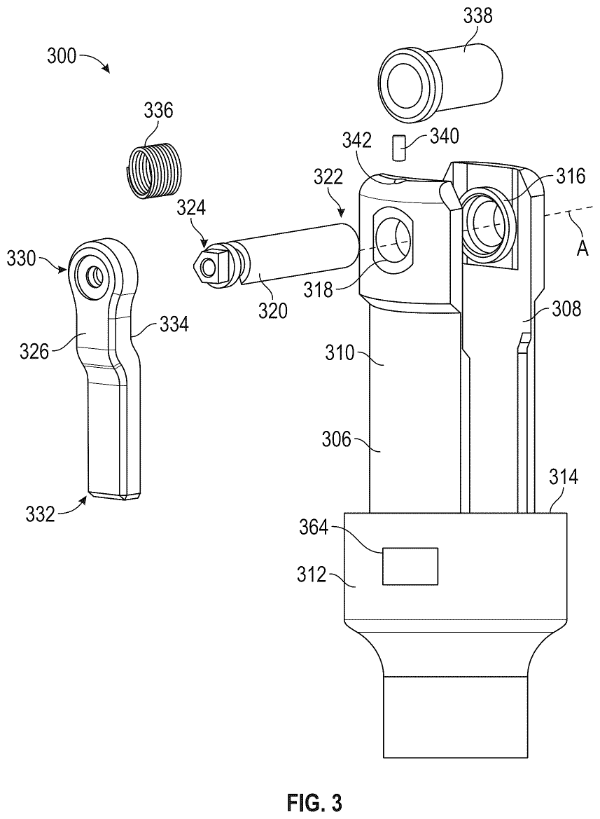

FIG. 3 illustrates an example clevis pin arrangement 300 that enables a first jaw 302 and a second jaw 304 of the working head 108 to be removably coupled to a yoke 306 of the power tool (e.g., such as hydraulic tool 100) without requiring the use of external tools, e.g., such as wrenches, pliers. The clevis pin arrangement 300 includes the yoke 306 having a first leg 308 and a second leg 310 that extend from a base 312 of the yoke 306. In this example, the yoke 306 is rotatably coupled with the cylinder 152 of the hydraulic tool 100. This rotatable coupling allows a user to rotate the working head 108 in a three hundred and sixty degree space relative to the housing 104 to position the jaws 302, 304 in a desired orientation to perform an operation while maintaining a connection between the yoke 306 and the hydraulic actuator 136.

In some cases, a clevis pin arrangement may include a ledge that extends from a housing circumferentially around a yoke. The ledge may provide a surface for engagement with a lever of the clevis pin arrangement. In some cases, a first leg of the yoke may define a first aperture and a second leg of the yoke may define a second aperture. The first aperture and the second aperture may be configured to receive and retain a clevis pin. When the clevis pin is inserted through both the first aperture and the second aperture, the clevis pin may secure a working head to the yoke. This configuration may define a locked configuration of the clevis pin arrangement. As illustrated in FIG. 3, a ledge 314 may extend from the housing 104 circumferentially around the first leg 308 and the second leg 310 of the yoke 306. The first leg 308 defines a first aperture 316. The second leg 310 defines a second aperture 318. The first aperture 316 and the second aperture 318 are configured to receive and retain a clevis pin 320. When the clevis pin 320 is inserted through both the first aperture 316 and the second aperture 318, the clevis pin 320 can secure the working head 108 to the yoke 306. More specifically, the clevis pin 320 may secure the jaws 302, 304 to the yoke 306. This configuration defines a first or locked configuration of the clevis pin arrangement 300.

In some cases, a clevis pin may have a first end and a second end opposite the first end. In a locked configuration, the first end may be received within a first aperture of a first leg of the yoke. The second end may be received within a second aperture of a second leg of the yoke. A lever may be coupled to the second end of the clevis pin. The lever may facilitate manipulation of the clevis pin by a user. As illustrated in FIG. 3, the clevis pin 320 has a first end 322 and a second end 324 opposite the first end 322. In the locked configuration, the first end 322 is received within the first aperture 316 of the first leg 308 and the second end 324 is received within the second aperture 318 of the second leg 310. A clevis lever 326 is removably coupled to the second end 324 of the clevis pin 320. The clevis lever 326 facilitates manipulation of the clevis pin 320 by a user. In other embodiments, the lever 326 may be configured as a knob, a dial, or a handle. Other configurations are also possible.

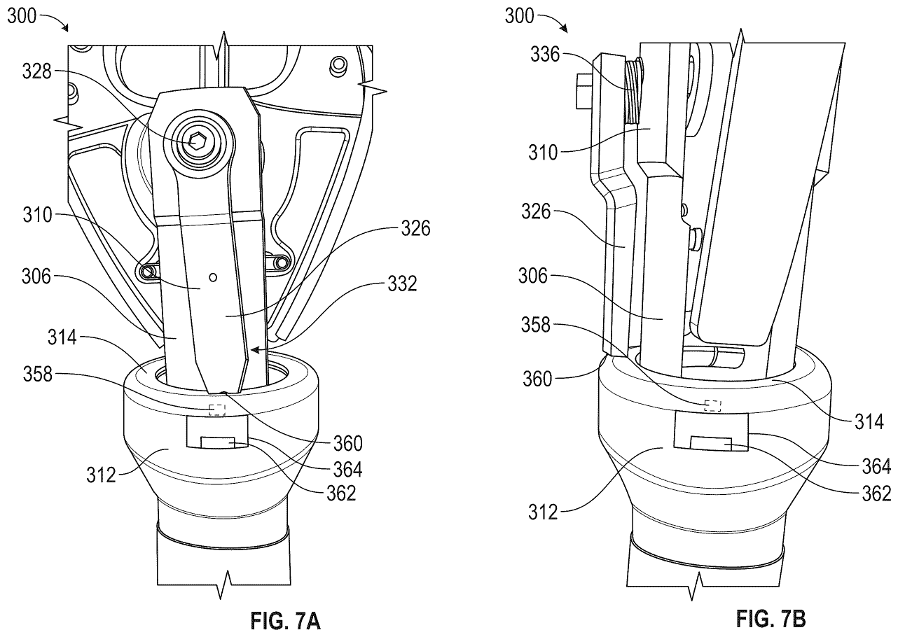

In some cases, a lever may be secured to a clevis pin by a fastener. The fastener may be a bolt, a screw, a circlip, or another type of fastener. In other cases, the lever may be secured to the clevis pin by a press-fit, an adhesive, a fusion-bond, a set screw, or another suitable arrangement. In still other cases, the lever may be integrally formed as a single piece with the clevis pin. As illustrated in FIG. 7A, the lever 326 is secured to the second end 324 by a fastener 328 (e.g., a bolt, screw, circlip). In other examples, the lever 326 is secured to the second end 324 by a press-fit, adhesive, fusion-bond, set screw, or any other suitable arrangement. Alternatively, in other embodiments, the lever 326 is integrally formed as a single piece with the clevis pin 320.

In some cases, a lever may include a proximal end and a distal end opposite the proximal end. The proximal end may be coupled to a clevis pin. The distal end may be configured to be manipulated by a user. Manipulation of the lever may rotate the clevis pin. This rotation may cause the clevis pin to move between a locked configuration and an unlocked configuration. In the locked configuration, the clevis pin may be secured within both a first aperture and a second aperture of a yoke. The lever may be oriented substantially parallel to a leg of the yoke in the locked configuration. In some cases, the lever may abut an outer surface of the leg in the locked configuration. In some cases, the distal end of the lever may engage with a ledge in the locked configuration. In the unlocked configuration, the clevis pin may not be secured within the first aperture. This may permit removal of jaws from the yoke. As further shown in FIG. 3, the lever 326 includes a proximal end 330 that is coupled to the clevis pin 320. A distal end 332 of the lever 326 is positioned opposite the proximal end 330. In this example, the distal end 332 of the lever 326 is configured to be manipulated by a user. Manipulation of the lever 326 correspondingly rotates the clevis pin 320. This rotation causes the clevis pin 320 to move between the locked configuration and an unlocked configuration. In the locked configuration, as noted above, the clevis pin 320 is secured within both the first aperture 316 and the second aperture 318 of the yoke 306. Furthermore, in the locked configuration, the lever 326 can be oriented substantially parallel to the second leg 310. In some examples, the lever 326 abuts an outer surface of the second leg 310 in the locked configuration. Additionally, in some embodiments, the distal end 332 of the lever 326 engages with the ledge 314 in the locked configuration, as will be further described below. In the unlocked configuration, the clevis pin 320 is not secured within the first aperture 316. This may permit removal of the jaws 302, 304 from the yoke 306, as will be further detailed below.

In this example, the lever 326 has a shape and profile that substantially corresponds with the shape and profile of the second leg 310. As shown in FIG. 3, the lever 326 includes a curved transition area 334 positioned between the proximal end 330 and the distal end 332. The curved transition area 334 is configured to conform with the contour of the second leg 310. In some embodiments, the curved transition area 334 allows for a flush engagement between the lever 326 and the second leg 310 when in the locked configuration. Alternatively, the curved transition area 334 allows the lever 326 to nest with the second leg 310 when in the locked configuration to reduce the overall profile of the clevis pin arrangement 300 and minimize the likelihood of the lever 326 being inadvertently displaced during operation of the tool 100.

In some cases, a clevis pin arrangement may include a spring to bias a lever and a clevis pin. The spring may be inserted on the pin. The spring may be positioned between a leg of the yoke and the lever. The spring may bias the lever outwardly relative to the yoke when the clevis pin is in the locked configuration. This outward bias may urge the clevis pin toward the unlocked configuration. In some cases, the spring may be a compression spring. In other cases, the spring may be a leaf spring, a torsion spring, or another biasing component. In some embodiments, the spring may be omitted. Referring still to FIG. 3, a spring 336 is inserted on the pin 320. The spring 336 may be positioned between the second leg 310 and the lever 326. The spring 336 biases the lever 326 (e.g., and the clevis pin 320) outwardly relative to the yoke 306 when the clevis pin 320 is in the locked configuration. This outward bias urges the clevis pin 320 toward the unlocked configuration. In the illustrated example, the spring 336 is a compression spring. In other examples, other spring types may be used. For example, a leaf spring, a torsion spring, or another biasing component may be used. In some embodiments, the spring 336 may be omitted.

In the illustrated example, a hollow, cylindrical sleeve 338 extends between and aligns with the first leg 308 and the second leg 310 of the yoke 306. The sleeve 338 receives the clevis pin 320 during the locked configuration, the unlocked configuration, and when the clevis pin 320 transitions between the locked and unlocked configurations. When assembled, the sleeve 338 extends through corresponding bearing eyes of the jaws that allows the jaws 302, 304 to pivot about the sleeve 338 (e.g., along axis A) during an operation. In this way, the sleeve 338 protects the clevis pin 320 from direct engagement with the jaws 302, 304 that reduces wear on the clevis pin 320 and extends the operational life. In other examples, the sleeve 338 is omitted and the jaws 302, 304 pivot directly about the clevis pin 320. In still other examples, the sleeve 338 can instead be configured as a bushing, a bearing (e.g., a roller bearing, a needle bearing, or a plain bearing), a liner, a wear ring, or a protective coating applied to the clevis pin 320. Alternatively, in other examples, the working head 108 includes jaws that pivot about separate axes.

In some cases, a clevis pin arrangement may include a stop pin to maintain the clevis in the locked configuration. The stop pin may resist rotational movement of the clevis pin until a user applies sufficient force to disengage the stop pin. For example, as shown in FIG. 3, a stop pin 340 is seated within a stop pin aperture 342 defined in the second leg 310. When installed, the stop pin 340 partially extends into the second aperture 318. In this way, the stop pin 340 is configured to engage the clevis pin 320 in both the locked configuration and the unlocked configuration, as will be further detailed below. In the illustrated example, the stop pin 340 is press-fit into the stop pin aperture 342. In other examples, the stop pin 340 can be secured within the stop pin aperture 342 by alternative arrangements, such as a threaded connection, an adhesive bond, or a snap-fit engagement. In still other examples, the stop pin 340 can be configured as a spring detent.

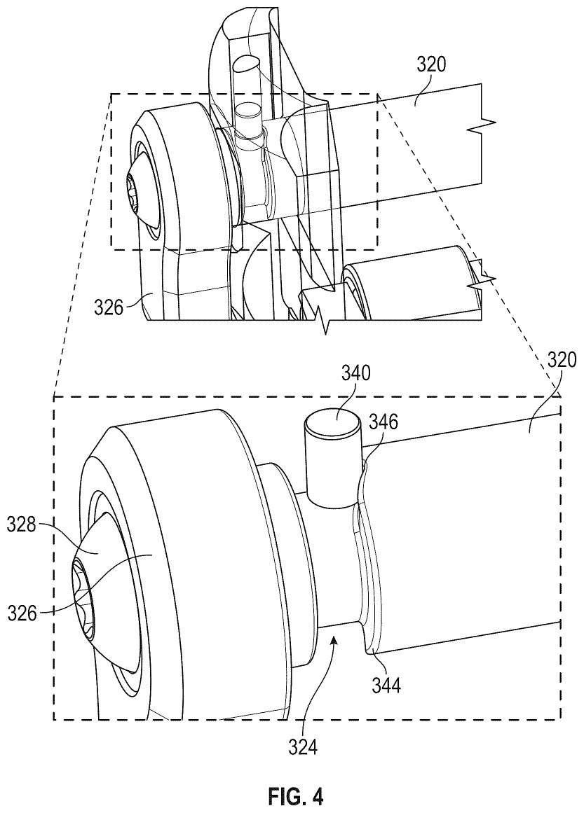

In some cases, a clevis pin arrangement may include a stop pin that engages the clevis pin to maintain the clevis in the locked configuration. The stop pin may resist rotational movement of the clevis pin until a user applies sufficient force to disengage the stop pin. The clevis pin may define a channel that extends circumferentially around the pin and a notch formed within the channel. The stop pin may engage the notch to resist rotational movement of the clevis pin until a user applies sufficient rotational force to disengage the stop pin from the notch. The channel may provide a continuous path that allows the stop pin to remain in contact with the clevis pin as the clevis pin rotates between the locked configuration and the unlocked configuration. Turning now to FIG. 4, the stop pin 340 may engage the clevis pin 320 at the second end 324 in the locked configuration. More specifically, the second end 324 of the clevis pin 320 may define a channel 344. The channel 344 extends into and circumferentially around the entire circumference of the clevis pin 320. The channel 344 provides a continuous path that allows the stop pin 340 to remain in contact with the clevis pin 320 as the clevis pin 320 rotates between the locked configuration and the unlocked configuration. A notch 346 is formed as a shallow groove within the channel 344. In particular, the notch 346 is formed as a depression in the channel 344 that extends radially inward toward the first end 322 of the pin 320 that receives and retains the stop pin 340 in the locked configuration. In operation, the stop pin 340 engages the notch 346 to maintain the clevis pin 320 in the locked configuration. The stop pin 340 resists rotational movement until a user applies sufficient rotational force to the lever 326 to disengage the stop pin 340 from the notch 346.

In some cases, a spring may bias a clevis pin outwardly relative to a yoke. This outward bias may urge a notch on the clevis pin into contact with a stop pin. This engagement may provide tactile feedback to a user. This engagement may also inhibit accidental rotation of the clevis pin out of a locked configuration. In some cases, a detent force may be created by the engagement between the notch and the stop pin. The detent force may be tuned by adjusting a spring constant of the spring. The detent force may also be tuned by adjusting a depth of the notch. The detent force may also be tuned by adjusting a profile of the stop pin. As noted above, the spring 336 biases the clevis pin 320 outwardly relative to the yoke 306. This outward bias urges the notch 346 into contact with the stop pin 340. This engagement may provide tactile feedback to the user. This engagement inhibits accidental rotation of the clevis pin 320 out of the locked configuration. The detent force created by the engagement between the notch 346 and the stop pin 340 may be tuned by adjusting the spring constant of the spring 336. The detent force may also be tuned by adjusting the depth of the notch 346. The detent force may also be tuned by adjusting the profile of the stop pin 340. In this way, the jaws 302, 304 are secured to the yoke 306 and prevented from unintentionally detaching during operation. That is, the jaws 302, 304 may remain secured when the hydraulic tool 100 is subjected to vibration or impact forces during use.

In some cases, a notch may have a size and profile configured to substantially match the size and profile of a stop pin. This matching may maintain engagement between the notch and the stop pin. In some cases, the notch may have a curved or arcuate profile. The curved or arcuate profile may correspond with a cylindrical or rounded profile of the stop pin. In other cases, the notch may have a V-shaped or tapered profile. The V-shaped or tapered profile may correspond with a conical or pointed profile of the stop pin. To maintain engagement between the notch 346 and the stop pin 340, the notch 346 may have a size and profile configured to substantially match the size and profile of the stop pin 340. For example, the notch 346 may have a curved or arcuate profile. The curved or arcuate profile corresponds with a cylindrical or rounded profile of the stop pin 340. In other examples, the notch 346 may have a V-shaped or tapered profile. The V-shaped or tapered profile corresponds with a conical or pointed profile of the stop pin 340.

To transition the clevis pin 320 from the locked configuration to the unlocked configuration, a user applies a pushing force to the lever 326 toward the second leg 310 to compress the spring 336 and overcome its outward bias. While maintaining this pushing force, the user rotates the lever 326 to disengage the notch 346 from the stop pin 340. During this rotational movement, the stop pin 340 travels along the channel 344. In some examples, the clevis pin 320 is rotated approximately one hundred and eighty degrees, although other angles such as ninety degrees are possible. Because the channel 344 extends circumferentially around the entire circumference of the clevis pin 320, the stop pin 340 remains engaged with the clevis pin 320 throughout the transition, retaining the clevis pin 320 within the second aperture 318 of the second leg 310 and preventing inadvertent separation of the clevis pin 320 from the yoke 306. In this way, the channel 344 and stop pin 340 arrangement reduces the number of components of the clevis pin arrangement 300 while maintaining secure retention of the clevis pin 320 in both the locked and unlocked configurations.

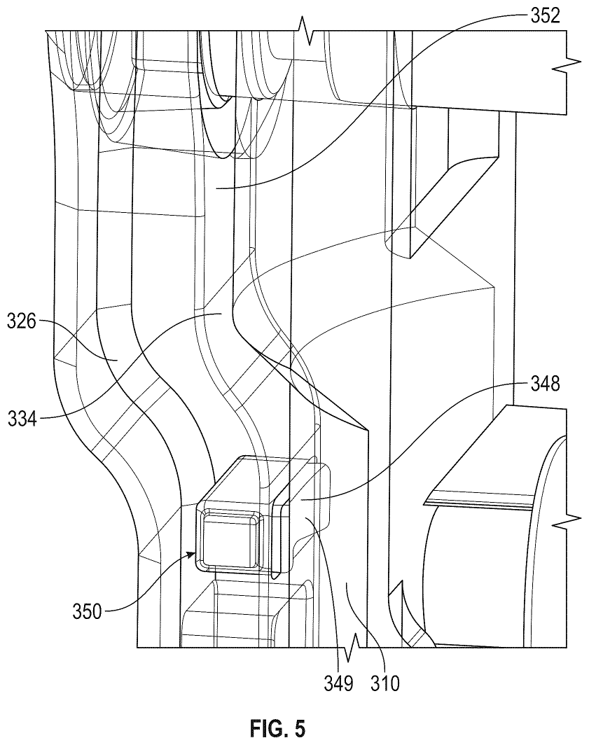

In some cases, a lock assembly may be coupled to a lever of a clevis to maintain the lever and a clevis pin in a locked configuration. The lock assembly may be positioned between a proximal end and a distal end of the lever. The lock assembly may be adjacent to a curved transition area of the lever. In some cases, a lever may define a recess on an interior surface that faces a yoke. The recess may receive and retain the lock assembly. In some cases, the lock assembly may include a locking member that is retained in the recess. The locking member may extend past the interior surface to engage a leg of the yoke in the locked configuration. In some cases, the locking member may apply a force to the yoke to bias the pin in a direction out of apertures in the yoke. This bias may engage a stop pin with a notch defined on the clevis pin. Referring now to FIG. 5, the lever 326 includes a lock assembly 348 that maintains the lever 326 and the clevis pin 320 in the locked configuration. The lock assembly 348 is coupled to the lever 326 at a position between the proximal end 330 and the distal end 332. The lock assembly 348 is adjacent to the curved transition area 334. The lever 326 defines a recess 350 on an interior surface 352 that faces the yoke 306. The recess 350 receives and retains the lock assembly 348. In some examples, the lock assembly 348 includes a locking member that is retained in the recess 350. When installed, the lock assembly 348 extends past the interior surface 352 of the lever 326 to engage the second leg 310 of the yoke 306 in the locked configuration. In some examples, the locking member applies a force to the yoke 306 to bias the pin 320 in a direction out of the first aperture 316 and the second aperture 318 to engage the stop pin 340 with the notch 346 defined at the second end 324 of the pin 320.

In some cases, a lock assembly may have an outer surface that is concave relative to a leg of the yoke. The concave profile may increase a contact area between the lock assembly and the leg. This increased contact area may enhance frictional engagement between the lever and the leg by dispersing the contact force while providing a greater frictional surface. The concave profile may also provide a physical detent similar to the pin and notch arrangement. This engagement may resist unintentional rotation of the lever. This engagement may also help maintain the clevis pin in the locked configuration during operation. In some cases, a recess may be sized to retain the lock assembly via an interference fit. This sizing may allow the lock assembly to be removed and replaced as needed. In other cases, the lock assembly may be integrally formed with the lever as a single component. In this example, the lock assembly 348 has an outer surface 349 that is concave relative to the second leg 310. The concave profile of the outer surface 349 increases the contact area between the lock assembly 348 and the second leg 310. This increased contact area further increases the contact force between the lock assembly 348 and the leg 310 while providing a greater frictional surface. This, in turn, enhances the holding force between the lever 326 and the second leg 310. Furthermore, the concave profile of the outer surface 349 also provides a physical detent mechanism similar to the pin and notch arrangement discussed above. In particular, this engagement between the lock assembly 348 and the second leg 310 resists unintentional rotation of the lever 326. As a result, this engagement helps maintain the clevis pin 320 in the locked configuration during operation of the hydraulic tool 100. In some examples, the recess 350 is sized to retain the lock assembly 348 via an interference fit. This sizing allows the lock assembly 348 to be removed and replaced as needed. In other embodiments, the lock assembly 348 is integrally formed with the lever 326 as a single component.

In the illustrated embodiment, the lock assembly 348 is made of a rubber or other elastomeric material that increases the coefficient of friction between the lever 326 and the second leg 310. The material of the lock assembly 348 allows the lock assembly 348 to resiliently deform when engaging the second leg 310, providing a secure connection that prevents a user from unintentionally disengaging the lever 326 from the second leg 310 and positioning the clevis pin 320 in the unlocked configuration. In other examples, the lock assembly 348 can be made of silicone, polyurethane, polyvinyl chloride (PVC), thermoplastic polyurethane (TPU), thermoplastic elastomer (TPE), ethylene vinyl acetate (EVA), or neoprene. In still other embodiments, the lock assembly 348 can be made of a rigid material, such as a metal or hard plastic, and can include surface texturing or coatings to enhance frictional engagement with the second leg 310 (e.g., the yoke 306).

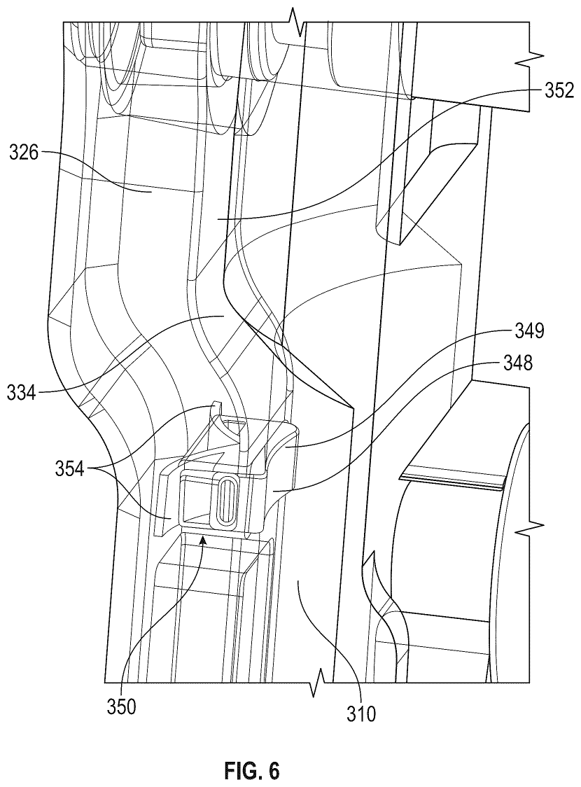

In some cases, a lock assembly may include a resilient member (e.g., a leaf spring, a compression spring, a torsion spring) to bias the lock assembly into engagement with a yoke. This engagement may resist unintentional displacement of the lever during operation. For example, as shown in FIG. 6, the lock assembly 348 includes a resilient member to bias the lock assembly 348 into engagement with the yoke 306. In some examples, the lock assembly 348 is made of a plastic material or another resilient material to maintain the lever 326 in the locked configuration. Similar to the lock assembly 348 of FIG. 5, the lock assembly 348 is positioned in the recess 350 of the lever 326. The lock assembly 348 of FIG. 6 further includes a leaf spring 354. The leaf spring 354 is positioned between the bottom of the recess 350 (e.g., relative to the distal end 332 of the lever 326) and the outer surface 349 of the lock assembly 348 that engages the yoke 306. The leaf spring 354 biases the outer surface 349 of the lock assembly 348 into engagement with the second leg 310. In this way, the leaf spring 354 allows the lock assembly 348 to resiliently engage the second leg 310 in the locked configuration. This resilient engagement prevents unintentional displacement of the lever 326 during operation of the hydraulic tool 100. In the illustrated embodiment, the leaf spring 354 is integrally formed with the main body 356 of the lock assembly 348, which can also be referred to as a locking member. More specifically, the leaf spring 354 is formed as a pair of leaf springs 354 that extend from opposite sides of the outer surface 349. In other examples, the leaf spring 354 can be a separate element. Correspondingly, in other embodiments, other biasing assembly types can be used in place of the leaf spring 354. For example, a compression spring, a torsion spring, a rubber element, or other biasing member can be used. In some aspects, two different spring types are used in combination to provide the desired biasing force.

In some cases, it can be beneficial for a user to know if the clevis pin arrangement is in the locked configuration. Correspondingly, it can be beneficial to indicate to a user when the clevis pin is locked or unlocked. For example, a power tool can include a sensor arrangement to detect when a clevis pin is in a locked or an unlocked configuration. The sensor arrangement can include a sensor (e.g., hall-effect, optical, proximity, or other type of sensor) coupled to a yoke or housing of a power tool to sense a position of the clevis pin. A controller can be in communication with the sensor to receive signals (e.g., such as a first signal and a second signal) from the sensor corresponding to the position of the clevis pin. Based on the received signals, the controller can provide an indication to a user when the clevis pin is in the locked configuration or the unlocked configuration. The indication can be auditory, visual, haptic, or another type of indication.

For example, as shown in FIG. 7A, a sensor 358 (e.g., a hall-effect sensor) may be supported on the yoke 306, the housing 104, or the cylinder housing 105 of the power tool 100. In the illustrated example, the sensor 358 extends circumferentially underneath the ledge 314. Correspondingly, the clevis lever 326 has a detectable element 360 (configured as a magnet in this example) on the distal end 332 that is configured to interact with the sensor 358 and couples to the sensor 358 in the locked configuration. When the detectable element 360 is in proximity to the sensor 358, the controller 140 can determine that the lever 326 is in the locked position. In some examples, the clevis lever 326 may not include a separate detectable element 360 but may instead be made of a material that is itself detectable by the sensor 358, such as a magnetic material or a metallic material. In this way, the sensor 358 is able to detect when the clevis lever 326 (and corresponding clevis pin 320) is in the locked configuration. In other examples, the detectable element can be configured as a reflective surface, a radio-frequency identification (RFID) tag, or a conductive element that interacts with the sensor 358.

In some cases, a sensor may be coupled to a controller of a power tool. The controller may disable a trigger when the clevis lever is determined to be in an unlocked position. This may prevent the power tool from performing an operation in the unlocked configuration. The controller may enable the trigger when the clevis lever is determined to be in the locked position. This may allow the power tool to perform an operation. This feature may enhance safety for a user. For example, the sensor 358 is coupled to the controller 140 of the power tool 100. When the clevis lever 326 is determined to be in an unlocked position, the controller 140 disables the trigger 120 of the power tool 100. In this way, the power tool 100 is prevented from performing an operation in the unlocked configuration. Conversely, when the clevis lever 326 is determined to be in the locked position, the controller 140 enables the trigger 120 to allow the power tool 100 to perform an operation. This feature enhances safety for a user such that a user does not unintentionally initiate an operation of the power tool 100 in the unlocked configuration.

Various sensor types can be used to detect a configuration of a clevis lever. In some examples, the sensor 358 is a proximity sensor that detects when the distal end 332 of the lever 326 is positioned adjacent to the ledge 314, indicating the locked configuration. In other examples, the sensor 358 is a hall effect sensor that detects the magnetic field generated by the detectable element 360 configured as a magnet on the lever 326 when the lever 326 is in the locked configuration. In still other examples, the sensor 358 can be a contact switch or limit switch that is mechanically actuated by engagement between the lever 326 and the ledge 314. In further examples, the sensor 358 can be an optical sensor, such as a photoelectric sensor or an infrared sensor, which detects the presence or absence of the lever 326 in a particular position. In yet other examples, the sensor 358 can be a capacitive sensor that detects changes in capacitance caused by the proximity of the lever 326. In some examples, the lever 326 or a portion thereof, such as the distal end 332, can include a metallic component, and the sensor 358 can be an inductive sensor configured to detect the presence of the metallic component when the lever 326 is in the locked configuration. In some cases, the sensor 358 can be activated when the clevis lever 326 is in the locked configuration and deactivated when the clevis lever 326 is in the unlocked configuration. Alternatively, the sensor 358 can be deactivated when the clevis lever 326 is in the locked configuration and activated when the clevis lever 326 is in the unlocked configuration.

In some cases, an inductive sensor may be used to detect the position of the clevis lever. The inductive sensor may detect changes in inductance caused by the proximity of a metallic component on the lever. The lever or a portion thereof (e.g., the distal end) may include a metallic component. The metallic component may be a metallic insert, a metallic plate, or a metallic coating. The inductive sensor may include an inductive coil that generates an electromagnetic field. When the metallic component on the lever enters the electromagnetic field, the inductance of the coil may change. The inductive sensor may detect this change in inductance and generate a signal indicating that the lever is in the locked configuration. For example, the sensor 358 may be configured as an inductive sensor that detects the presence of a metallic component on the distal end 332 of the lever 326. The inductive sensor may be positioned beneath the ledge 314 and may extend circumferentially around the yoke 306, similar to the hall-effect sensor arrangement described above. In some cases, the inductive coil may extend circumferentially around the yoke. This circumferential arrangement may allow the inductive sensor to detect the metallic component regardless of the angular position of the yoke relative to the housing. In some cases, the inductive sensor may include multiple coils arranged at intervals around the yoke. The inductive sensor may provide robust detection without requiring a permanent magnet on the lever. In some cases, the inductive sensor may be less susceptible to interference from external magnetic fields. The inductive sensor may also be less affected by debris or contamination on the lever or the yoke.

In some cases, a controller can provide an indication (e.g. visual, tactile, auditory, or another type of indication) to a user to indicate whether a clevis is locked or unlocked. In the illustrated example, the clevis pin arrangement 300 includes a light emitting diode (e.g., LED 362) that is coupled to the controller 140. The controller 140 controls an activation state of the LED 362 (e.g., activated or deactivated) to indicate a state of the clevis lever 326. For example, the controller 140 can be configured to turn on the LED 362 when the sensor 358 detects that the clevis pin 320 is in the locked configuration, with the LED 362 emitting a first color (e.g., green, blue, red, white, or another color) or producing a flashing light as an indication to a user of the locked configuration. The LED 362's indication to a user is visible through a window 364 on the yoke 306 that is transparent and enables a user to see the status of the LED 362.

In some cases, the LED 362 may be a single-color LED, a bi-color LED, or a multi-color RGB LED. The LED 362 may emit light in a visible spectrum, such as red, green, blue, amber, or white. In some aspects, the LED 362 may be a surface-mount device (SMD) LED, a through-hole LED, or a chip-on-board (COB) LED. The LED 362 may be mounted on a circuit board that is positioned within the yoke 306 or the housing 104. In some cases, the window 364 may be formed from a transparent or translucent material, such as polycarbonate, acrylic, glass, or silicone. The window 364 may be flush with an outer surface of the yoke 306 or may be recessed within a pocket defined in the yoke 306. In some aspects, the window 364 may include a lens or a diffuser that spreads the light emitted by the LED 362 to increase visibility from multiple viewing angles. In other aspects, the window 364 may be tinted or colored to filter the light emitted by the LED 362 or to provide a desired aesthetic appearance. In some cases, the window 364 may be sealed to the yoke 306 by an O-ring, a gasket, or an adhesive to prevent ingress of moisture and debris.

Alternatively, the controller 140 can provide other types of indications such as an auditory indication (e.g., a beep, tone, or alarm sound), a haptic indication (e.g., a vibration pattern transmitted through the housing 104 or a handle of the power tool 100), a message or icon on a display screen coupled to the power tool 100, or a notification transmitted to a mobile device or remote monitoring system via a wireless communication module. In some aspects, the controller 140 can provide multiple types of indications simultaneously or sequentially to ensure the user is aware of the configuration of the clevis.

In some cases, a yoke may be rotatable relative to a tool body. The sensor may be configured to detect the position of the clevis lever independent of the rotational position of the yoke. As illustrated in FIG. 7B, the yoke 306 may allow a user to rotate the working head 108 in a three hundred and sixty degree space relative to the base 312 in the locked configuration to position the working head 108 in a desired orientation for use. Because the yoke 306 may rotate relative to the base 312, the sensor 358 may be configured to detect the position of the clevis lever 326 independent of the rotational position of the yoke 306. In some examples, the sensor 358 may include a sensing element (e.g., a sensing coil) that extends the entire circumference of the power tool 100 at the ledge 314. This circumferential arrangement may help the detectable element 360 on the clevis lever 326 remain detectable by the sensor 358 regardless of the angular position of the yoke 306 relative to the housing 104. In other examples, an array of sensors 358 may be distributed around the yoke 306 to provide detection coverage at multiple angular positions. In still other examples, the sensor 358 may be coupled to the yoke 306 and rotate with the yoke 306 relative to the base 312. A slip ring or wireless communication module may transmit signals from the sensor 358 to the controller 140.

In some cases, the sensing element of the sensor 358 may be formed as a continuous ring or annulus that extends around the entire circumference of the ledge 314. The continuous ring may be formed from a flexible circuit board, a printed circuit, or a wire coil that is shaped to conform to the circumference of the ledge 314. In some aspects, the sensing element may include a plurality of conductive traces or windings that are arranged in a serpentine pattern around the circumference of the ledge 314. The sensing element may be encapsulated in a protective material, such as an epoxy, a silicone, or a potting compound, to protect the sensing element from moisture, dust, and mechanical damage. In other cases, the sensing element may be formed from a plurality of discrete sensing segments that are electrically connected in series or in parallel. The discrete sensing segments may be spaced at regular intervals around the circumference of the ledge 314, such as at intervals of 30 degrees, 45 degrees, 60 degrees, or 90 degrees. In some aspects, the sensing segments may be mounted on a rigid or flexible substrate that is secured to the ledge 314 by adhesive, fasteners, or an interference fit.

In some cases, the detectable element 360 on the distal end 332 of the lever 326 may be a permanent magnet, such as a neodymium magnet, a samarium-cobalt magnet, a ferrite magnet, or an alnico magnet. In particular, the magnet may be embedded within the material of the lever 326, secured to a surface of the lever 326, or retained within a pocket or recess defined in the lever 326. In some aspects, the magnet may have a cylindrical, rectangular, or disc-shaped geometry. The magnet may be oriented with its magnetic poles aligned axially, radially, or diametrically relative to the lever 326. In other cases, the detectable element 360 may be a passive RFID tag that is configured to communicate with an RFID reader integrated into the sensor 358. The RFID tag may store identification information, such as a serial number or a type code, which can be read by the sensor 358 to identify the lever 326 or the working head 108. In still other cases, the detectable element 360 may be a reflective surface, such as a mirror, a retroreflector, or a reflective tape, which reflects light emitted by an optical sensor. In further cases, the detectable element 360 may be a conductive element that changes the capacitance or inductance detected by the sensor 358 when the lever 326 is in the locked configuration.

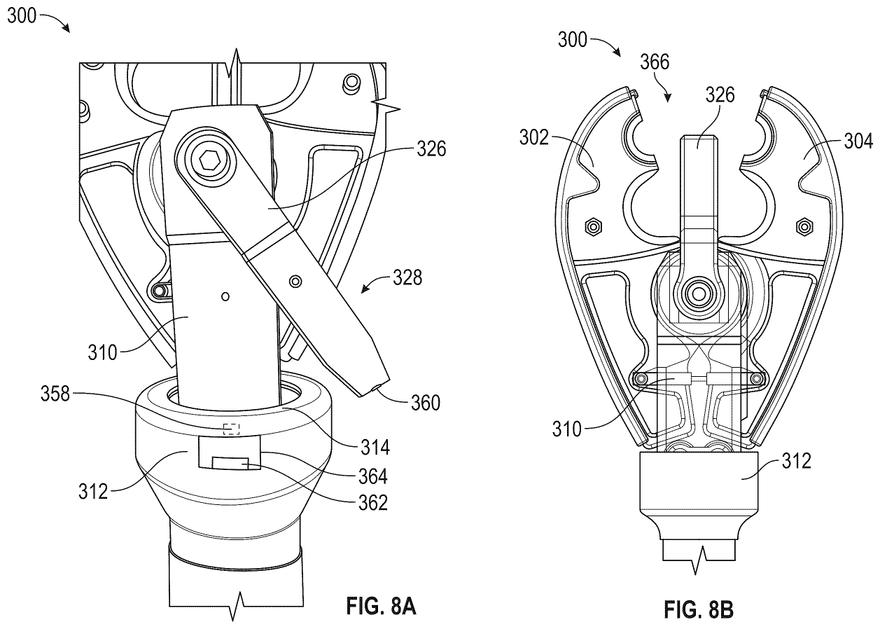

In some cases, a clevis lever may be rotated away from a locked configuration to an unlocked configuration. In the unlocked configuration, the sensor may be deactivated. The controller may disable the trigger when the sensor is deactivated. As illustrated in FIGS. 8A and 8B, the clevis pin arrangement 300 may be in the unlocked configuration. In the unlocked configuration, the clevis lever 326 may be rotated away from the ledge 314. This rotation may move the detectable element 360 of the lever 326 away from the sensor 358, causing the sensor 358 to be deactivated. When the sensor 358 is deactivated, the controller 140 may disable the trigger 120. Accordingly, tool operation may also be disabled when the clevis pin arrangement 300 is in the unlocked configuration.

In some cases, an LED may be turned off when the sensor detects that the clevis pin is in the unlocked configuration. Alternatively, the LED may emit a color different than the color used to indicate that the clevis pin is in the locked configuration. As illustrated in FIG. 8A, when the sensor 358 detects that the clevis pin 320 is in the unlocked configuration, the LED 362 may be turned off (e.g., deactivated). In some examples, the LED 362 may emit a red color in the unlocked configuration and a green color in the locked configuration. In still other examples, the LED 362 may emit a flashing light to indicate to a user that the tool 100 is in the unlocked configuration and is unable to be operated.

In some cases, a clevis lever may be moved to a position that blocks use of jaws when the clevis pin is in the unlocked configuration. This positioning may provide an additional indication to the user that the clevis pin is unlocked. As illustrated in FIG. 8B, the clevis lever 326 may be rotated approximately one hundred and eighty degrees from the ledge 314. In this position, the clevis lever 326 may be located between the first jaw 302 and the second jaw 304 that defines a workspace 366. In this way, the clevis lever 326 may inhibit a workpiece from being inserted into the workspace 366 and thus may inhibit the jaws 302, 304 from closing on a workpiece. Furthermore, even if a user initiated an operation, the controller 140 may be disabled such that no action will be performed. Accordingly, the clevis lever 326 may provide both a visual indication and a physical barrier to indicate to a user that the tool 100 cannot perform an operation in the unlocked configuration. This dual indication may enhance user safety by providing redundant feedback regarding the configuration of the clevis pin arrangement 300.

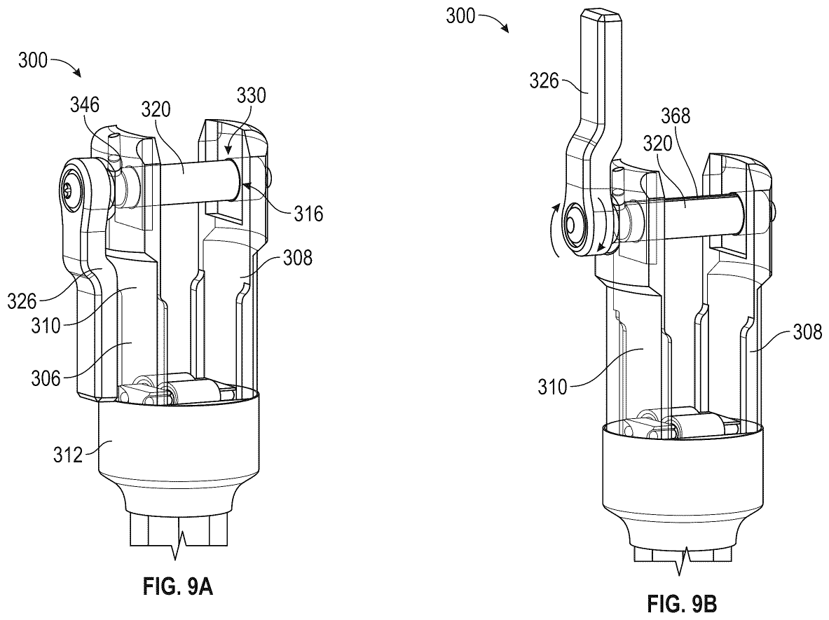

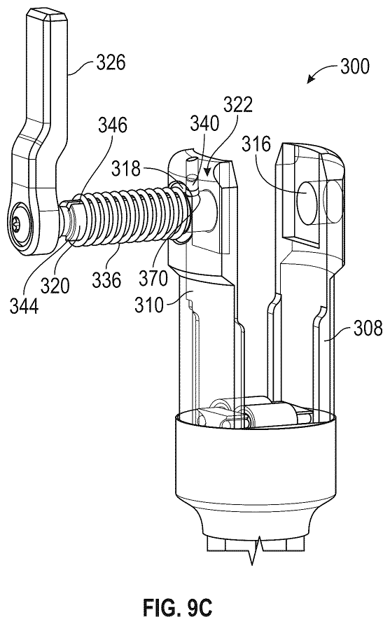

FIGS. 9A-9C illustrate a method of removing the clevis pin 320 from the yoke 306, according to one aspect of the disclosure. As shown in FIG. 9A, the clevis pin 320 is in the locked configuration. In this example, the clevis lever 326 is substantially parallel with the second leg 310 of the yoke 306. Furthermore, the first end 322 of the clevis pin 320 is secured within the first aperture 316 of the first leg 308. Additionally, the spring 336 positioned between the second leg 310 and the lever 326 is compressed. In this configuration, a stop pin 340 is seated within the notch 346 defined at the second end 324 of the clevis pin 320, maintaining the clevis pin 320 in the locked configuration.

As shown in FIG. 9B, the lever 326 is rotated approximately one hundred and eighty degrees in either direction from the locked configuration in FIG. 9A. This rotation moves the clevis lever 326 out of engagement with the second leg 310. The clevis lever 326 is subsequently positioned in the unlocked configuration. In the unlocked configuration, the power tool 100 is prevented from performing an operation. As further shown in FIG. 9B, the clevis pin 320 defines a groove 368 (which can also be referred to as a slot) that extends longitudinally along a length of the pin 320. The groove 368 is positioned upwardly (e.g., relative to the base 312) in this position and is circumferentially spaced from the notch 346. In some examples, the notch 346 is spaced approximately one hundred and eighty degrees from the groove 368 so that the lever 326 extends away from the tool body (e.g., the base 312 or housing 104) in the unlocked configuration and toward the tool body in the locked configuration. In the unlocked configuration, the stop pin 340 is received within the groove 368, which permits axial movement of the clevis pin 320 (and lever 326) relative to the yoke 306. In the position of FIG. 9B, the spring 336 remains compressed. This compression maintains the position of the clevis pin 320 between the first leg 308 and the second leg 310, thereby retaining the clevis pin 320 within the yoke 306 even though the clevis lever 326 has been rotated to the unlocked configuration.

After further rotation, such as shown in FIG. 9C, the spring 336 extends. This extension allows the first end 322 of the clevis pin 320 to be slidably removed from the first aperture 316 of the first leg 308. During this sliding movement, the stop pin 340 slides along the groove 368 of the pin 320 and seats within a notch 370 at an end of the groove 368. The groove 368 extends from the second end 324 of the pin 320 toward the first end 322, providing a path for the stop pin 340 to travel as the clevis pin 320 is withdrawn from the first leg 308. In this embodiment, the clevis pin 320 remains secured to the second leg 310 through engagement of the stop pin 340 with the channel 344 of the clevis pin 320, as discussed above. More specifically, the stop pin 340 engages the channel 344 to retain the clevis pin 320 within the second aperture 318 of the second leg 310. This arrangement prevents inadvertent separation of the clevis pin 320 from the yoke 306 while permitting removal or installation of the jaws 302, 304.

Conversely, to position clevis pin 320 in the locked configuration from the unlocked configuration, a user moves the first end 322 of the clevis pin 320 through the second leg 310. The user continues to move the first end 322 into engagement with first aperture 316 of first leg 308. This movement compresses the spring 336 and causes the stop pin 340 to slide along the groove 368 toward the second end 324 of the clevis pin 320. The user then rotates the clevis lever 326 approximately one hundred and eighty degrees in either direction. The user engages the distal end 332 of the clevis lever 326 with the second leg 310. As discussed above, the spring 336 biases the clevis pin 320 outwardly, urging the stop pin 340 into engagement with the notch 346. This engagement maintains the clevis pin 320 in the locked configuration and provides tactile feedback to the user indicating that the clevis pin 320 is properly secured.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

The above discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. The above detailed description is to be read with reference to the figures, in which like elements in different figures have like reference numerals. The figures, which are not necessarily to scale, depict selected embodiments and are not intended to limit the scope of embodiments of the invention. Skilled artisans will recognize the examples provided herein have many useful alternatives and fall within the scope of embodiments of the invention.

It is to be understood that the invention is not limited in its application to the details of construction and the arrangement of components set forth in the following description or illustrated in the attached drawings. The invention is capable of other embodiments and of being practiced or of being carried out in various ways. Also, it is to be understood that the phraseology and terminology used herein is for the purpose of description and should not be regarded as limiting. For example, the use of “including,” “comprising,” or “having” and variations thereof herein is meant to encompass the items listed thereafter and equivalents thereof as well as additional items.

Also as used herein, ordinal numbers are used for convenience of presentation only and are generally presented in an order that corresponds to the order in which particular features are introduced in the relevant discussion. Accordingly, for example, a “first” feature may not necessarily have any required structural or sequential relationship to a “second” feature, and so on. Further, similar features may be referred to in different portions of the discussion by different ordinal numbers. For example, a particular feature may be referred to in some discussion as a “first” feature, while a similar or substantially identical feature may be referred to in other discussion as a “third” feature, and so on.

Unless otherwise specified or limited, the terms “about” and “approximately,” as used herein with respect to a reference value, refer to variations from the reference value of ±15% or less (e.g., ±10%, ±5%, etc.), inclusive of the endpoints of the range.

The description of the different advantageous embodiments has been presented for purposes of illustration and description and is not intended to be exhaustive or limited to the embodiments in the form disclosed. Many modifications and variations will be apparent to those of ordinary skill in the art. Further, different advantageous embodiments may provide different advantages as compared to other advantageous embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A power tool comprising:
a tool body including a user input and a controller to control operation of the power tool based in response to a first signal from the user input;
a yoke coupled to the tool body and including a first leg defining a first aperture and a second leg defining a second aperture;
a clevis including:
a pin that is insertable into the first aperture and the second aperture and rotatable relative to the yoke to transition the clevis between a locked configuration and an unlocked configuration to removably couple a jaw assembly to the yoke, and
a lever at a second end of the pin that is positioned external to the yoke; and
a sensor coupled to at least one of the tool body, the yoke, or a housing of the power tool to sense when the clevis is in one of the locked configuration or the unlocked configuration, the sensor sending a second signal to the controller so that the controller provides an indication to a user corresponding to the configuration of the clevis.

2. The power tool of claim 1, wherein the sensor is a hall-effect sensor.

3. The power tool of claim 1, wherein the sensor is coupled to the tool body and the yoke is rotatable relative to the tool body.

4. The power tool of claim 1, wherein the controller controls an activation state of a light visible through a window on the yoke to provide the indication to the user based on the sensed configuration of the clevis.

5. The power tool of claim 1 further comprising a lock that is coupled to the lever, the lock engaging the yoke to resist movement of the clevis away from the locked configuration.

6. The power tool of claim 5, wherein the lock includes a locking member that is retained in a recess in the lever.

7. The power tool of claim 6, wherein the lock includes a spring to bias the locking member into contact with the yoke in the locked configuration.

8. The power tool of claim 7, wherein the spring is a leaf spring that is formed as a unitary component with the locking member.

9. The power tool of claim 6, wherein the locking member applies a force to the yoke to bias the pin in a direction out of the first aperture and the second aperture to engage a yoke detent with a notch defined at the second end of the pin.

10. The power tool of claim 1, wherein the sensor is an inductive sensor that detects a metallic component on the lever.

11. The power tool of claim 1, wherein the sensor includes a sensing element that extends circumferentially around the yoke.

12. The power tool of claim 1, wherein the lever includes a detectable element at a distal end of the lever, the detectable element configured to interact with the sensor when the lever is in the locked configuration.

13. A clevis for removably coupling a working head to a power tool, the clevis comprising:
a pin having a first end and a second end opposite the first end, the pin defining a circumferential channel extending around an outer surface of the pin at the second end and a notch formed within the channel, the notch extending radially inward from the channel;
a lever coupled to the second end of the pin and configured to rotate the pin between a locked configuration and an unlocked configuration, the lever defining a recess; and
a lock including a locking member retained in the recess, the locking member extending out of the recess to provide frictional engagement in the locked configuration.

14. The clevis of claim 13, wherein the lever is oriented substantially parallel to an axis of the power tool in the locked configuration.

15. The clevis of claim 13, wherein the locking member is made of an elastomeric material.

16. The clevis of claim 13, wherein the lever includes a detectable element at a distal end of the lever configured to interact with a sensor when the lever is in the locked configuration.

17. The clevis of claim 13, wherein the locking member has an outer surface that is concave relative to a leg of the power tool.

18. A power tool comprising:
a housing;
a yoke rotatably coupled to the housing, the yoke having a first leg with a first aperture and a second leg with a second aperture;
a clevis pin extending through the first aperture and the second aperture, the clevis pin rotatable between a locked configuration securing a working head to the yoke and an unlocked configuration permitting removal of the working head;
a lever coupled to the clevis pin and positioned external to the second leg, the lever movable to rotate the clevis pin between the locked configuration and the unlocked configuration;
a sensor that detects a position of the lever; and
a controller that disables operation of the power tool when the sensor detects the clevis pin is in the unlocked configuration.

19. The power tool of claim 18, wherein the lever is positioned to block a workspace defined between a first jaw and a second jaw of the working head in the unlocked configuration, preventing a workpiece from being inserted into the workspace.

20. The power tool of claim 18, wherein the sensor extends circumferentially around the yoke and the lever includes a sensed element at a distal end of the lever that is detectable by the sensor in the locked configuration.
